(19) United States
(12) Patent Application Publication
(10) Pub. No.: US 2007/0263834 A1
(43) Pub. Date: Nov. 15, 2007

(54) Execution of interactive voice response test cases

(75) Inventors: Brent Michael Jensen, Bothell, WA (US); Jianyun Tao, Bellevue, WA (US); Michael Robert Friend, Kirkland, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/392,012

(22) Filed: Mar. 29, 2006

(51) Int. Cl. H04M 7/00

(52) U.S. Cl. 379/235

(57) ABSTRACT

A network independent computer-implemented method of executing test cases on interactive voice response (IVR) systems is provided. A test driver and a call controller on a test driver virtual machine configure one or more IVR virtual machines to participate in a test case. User simulators on each IVR virtual machine are configured and loaded by the IVR product to be tested, which also resides on the IVR virtual machine. Under control of the call controller, the IVR virtual machines establish a call connection between their respective IVR products over a telephony network. The call controller then synchronously sends commands to the user simulators on each IVR virtual machine to control execution of the test case using the call connection. Execution of the test case is monitored by the test driver on the test driver virtual machine to evaluate IVR product performance.

### BACKGROUND

Interactive voice response (IVR) systems are increasingly being used in a variety of applications, for example in telephony based applications such as call answering systems, voice navigated systems, automated call generation systems, etc. Testing of IVR products used in IVR systems is common for purposes of evaluating, debugging and otherwise improving the systems. Automation of this testing is also finding increasing use.

The challenges associated with automation of IVR system testing are significant and encompass a variety of different tasks. For example, simulation of incoming and outgoing telephone calls (a.k.a. call control), including dialing, disconnecting, holding, forwarding, etc., presents one set of challenges. Another set of challenges relates to controlling the interactive stimuli and response of the “end user” once the call has been connected. This includes, but is not limited to, recognition of Fax calls, DTMF tones, and human voice.

Addressing these tasks in a fashion that controls/utilizes the network topology in which the two endpoints (the IVR system and the “end user”) are connected presents another set of challenges. The possibilities for this are vast. Typically, the IVR side of the communication is well understood, but the ‘end user’ side may be difficult to automate (e.g., a piece of OEM hardware that has a telephone connector as it's only input interface). It is a significant challenge to create deterministic test cases, in environments in which the matrix of network topology configurations can very quickly become inapproachable, without having to create test case code that is specific to each configuration.

The discussion above is merely provided for general background information and is not intended to be used as an aid in determining the scope of the claimed subject matter.

### SUMMARY

To address some challenges associated with testing interactive voice response (IVR) systems in environments where the network topology configurations can be vast, a network independent computer-implemented method of executing test cases on IVR systems is provided. A test driver and a call controller residing on a test driver virtual machine are used to configure one or more IVR virtual machines to participate in a test case. User simulators on each IVR virtual machine are configured and loaded by the IVR product under test, which also resides on the IVR virtual machine. Under control of the call controller, the IVR virtual machines establish a call connection between their respective IVR products over a telephony network. The call controller then synchronously sends commands to the user simulators on each IVR virtual machine to control execution of the test case using the call connection. Execution of the test case is monitored by the test driver on the test driver virtual machine to evaluate IVR product performance.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a one computing environment in which some embodiments may be practiced.

FIG. 2 is a block diagram of an interactive voice response (IVR) test system embodiment.

FIG. 3 is a block diagram of an alternate IVR test system embodiment.

FIG. 4 is a block diagram illustrating aspects of some embodiments.

FIG. 5 is a block diagram illustrating aspects of some alternate embodiments.

FIGS. 6-10 are flow diagrams illustrating method embodiments.

### DETAILED DESCRIPTION

As noted, interactive voice response (IVR) systems are finding increasing use in a variety of applications. Automating tests of IVR systems in a manner that does not require that test code be written specifically for each possible configuration is challenging. To address this issue, disclosed embodiments include methods and systems which automate IVR products and the network topology that makes up the end-to-end system, simultaneously. The disclosed embodiments provide the ability to create an automated test case that interacts with the IVR system, and also allow the same test to be repurposed to an entirely different network topology.

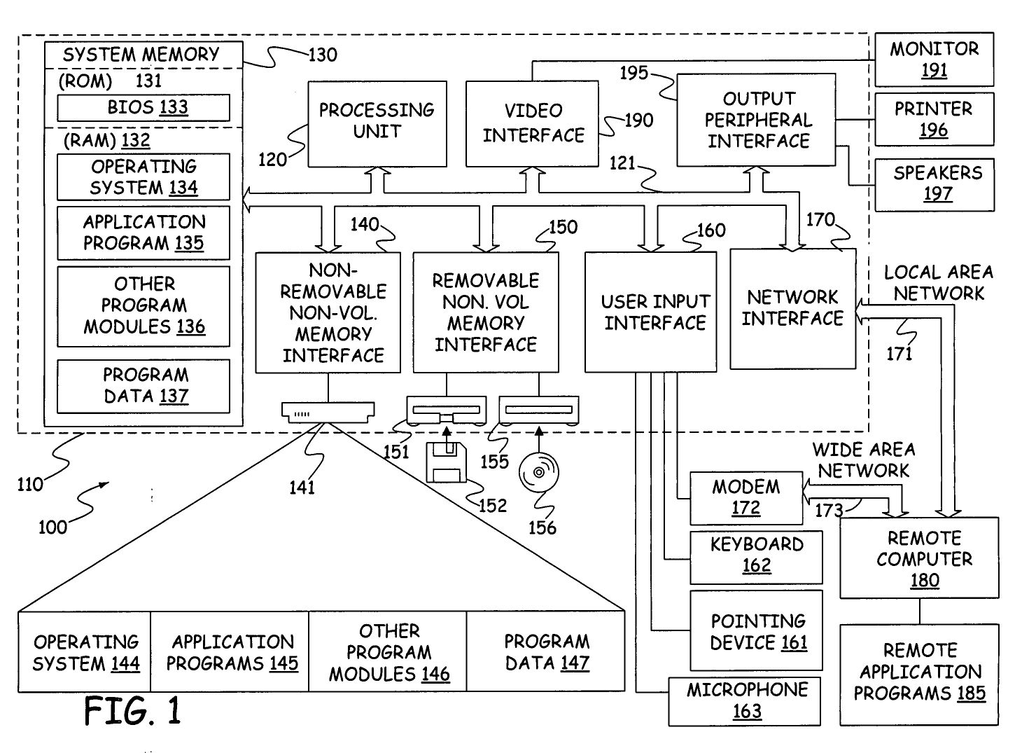

The disclosed IVR test case execution methods, apparatus and systems can be embodied in a variety of computing environments, including personal computers, hand held computers, laptop computers, notebook computers, server computers, etc. Before describing the embodiments in greater detail, a discussion of an example computing environment in which the embodiments can be implemented may be useful. FIG. 1 illustrates one such computing environment which can represent any of these different types of computing environments. As such, FIG. 1 should be understood to represent a computing environment configured to implement one or more aspects of the disclosed methods, systems or apparatus.

FIG. 1 illustrates an example of a suitable computing system environment 100 on which one or more aspects of the illustrated embodiments may be implemented. The computing system environment 100 is only one example of a suitable computing environment and is not intended to suggest any limitation as to the scope of use or functionality of the illustrated embodiments. Neither should the computing environment 100 be interpreted as having any dependency or requirement relating to any one or combination of components illustrated in the exemplary operating environment 100.

The illustrated embodiments are operational with numerous other general purpose or special purpose computing system environments or configurations. Examples of well-known computing systems, environments, and/or configurations that may be suitable for use with the illustrated embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The illustrated embodiments may be described in the general context of computer-executable instructions, such as program modules, being executed by a computer. Generally, program modules include routines, programs, objects, components, data structures, etc. that perform particular tasks or implement particular abstract data types. The illustrated embodiments may also be practiced in distributed computing environments where tasks are performed by remote processing devices that are linked through a communication network. In a distributed computing environment, program modules may be located in both local and remote computer storage media including memory storage devices. Tasks performed by the programs and modules are described below and with the aid of figures. Those skilled in the art can implement the description and figures provided herein as processor executable instructions, which can be written on any form of a computer readable medium.

With reference to FIG. 1, an exemplary system includes a general-purpose computing device in the form of a computer 110. Components of computer 110 may include, but are not limited to, a processing unit 120, a system memory 130, and a system bus 121 that couples various system components including the system memory to the processing unit. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

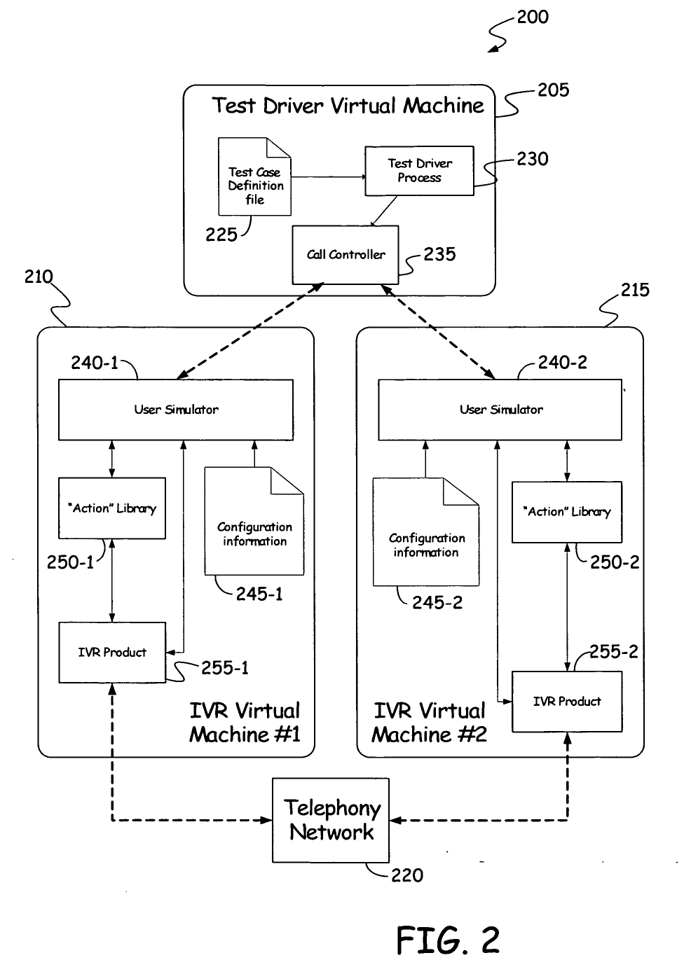

Referring now to FIG. 2, shown is a first embodiment of a system 200 for executing test cases on IVR products or systems. This diagram illustrates intercommunication amongst the components in the system for a common IVR scenario (an end user calling into an IVR machine). Virtual Machines are indicated as the components are not tied to any particular physical machine or computing device, and in the example shown, all three virtual machines can co-exist on the same physical machine or on different physical machines in various embodiments. In FIG. 2, dotted lines indicate inter-machine communication, while solid lines indicate intra-machine communication. As will be understood to those of skill in the art, a virtual machine is software that mimics the performance of a hardware device. Generally, a virtual machine includes protected memory space that is created through the processor's hardware capabilities.

As shown in FIG. 2, system 200 includes two types of virtual machines, test driver virtual machine 205 and IVR virtual machines 210 and 215. As will be described, the IVR product(s) 255-1 and/or 255-2 to be tested reside on the IVR virtual machines 210 and 215, while the test case execution (e.g., including monitoring and control) components reside on the test driver virtual machine 205.

The test driver virtual machine 205 includes a test case definition file 225, a test driver or process 230, and a call controller 235. Test case definition file 225 contains the configuration information (phones numbers, physical machine names, etc) of the participants in the call to be simulated as well as the set of actions defining what is to occur during the call. The definition file can in some embodiments specify one or more calls to occur either in parallel or serially. Each call may utilize the same set of test case actions or each call may have differing sets of actions. The test driver process 230 is responsible for hosting the call controller 235 and parsing the test case definition file 225, then performing the activity specified in the file. Call controller 235 is configured to be the synchronization point between the test driver 230 and the user simulators 240-1 and 240-2 (described below) participating in the call. Call controller 235 also distributes the configuration information for the run to the virtual machines 210 and 215.

Although IVR virtual machines 210 and 215 (designated IVR Virtual Machine #1 and IVR Virtual Machine #2) will typically be configured differently during the test case execution, they share common components which are described below. When discussing the components of virtual machines 210 and 215 generically, the common reference numbers are used to describe the components which reside in each system (e.g., 240), but when differences are being described, the more specific designations are used (e.g., 240-1 and 240-2).

At least one IVR virtual machine is required in embodiments of the system 200. In some cases, only one is useful when an actual user or an IVR application interacting with the IVR product and the test driver 230 is desired. An IVR application is any application built upon an IVR system that can accept or make phone calls (e.g., via Voice over Internet Protocol or VOIP, via Public Switched Telephone Network or PSTN, or via other related technologies) which interacts with users by voice. In other embodiments, two IVR virtual machines are employed to implement a fully automated end-to-end test case. In various embodiments, a “User simulator” can be 1) an actual user, 2) a test hook library (as diagramed in 240-1) or 3) an IVR application. The design of these embodiments handles controlling either one party or both parties in a call. In other words, at least one of the parties needs to be the test hook library.

Each IVR virtual machine includes a user simulator 240. The user simulator can be implemented as an application for the IVR system or as a shim on top of the IVR work engine or product 255. The user simulator 240 of each IVR virtual machine is coupled to the call controller 235 of the test driver virtual machine, and is configured with the functionality to call into the action library 250. A configuration information file 245 is used to store physical machine locations for the call controller 235 and for the user simulators 240. The above-mentioned action library 250 is a library of atomic synchronous methods or functions that automate the IVR product 255 which is to be tested.

Telephony network 220 represents the physical connection(s) that the IVR product 255 uses to connect to the real-world. This topology can be vast and complicated. Disclosed embodiments require only that each of IVR virtual machines 210 and 215 participating in the test execution be connected to the same telephony network.

The following discussion illustrates an example of how the components described above and illustrated in FIG. 2 function together as a system. Prior to running a test case, the test case definition file 225 is first scripted such that it contains the information specified above. To initiate the test case, the test driver 230 is launched. Test driver 230 loads the definition file 225 to determine the call configuration characteristics as well as the test case activity information. Then, the test driver 230 initiates the call controller 235, and informs the call controller to transfer the call configuration information and the physical machine location of the call controller to each of the physical IVR machines participating in the call.

Then, the test driver 230 establishes a call connection between the two user simulators 240-1 and 240-2. It does this by first triggering the mechanism in IVR product 255-1 for placing an outbound call and indicating that the user simulator 240-1 is the application that the IVR product should load. When the outbound user simulator (i.e., user simulator 240-1) loads, it first loads the configuration files from the call controller (stored in configuration files 245-1) and establishes a connection to the call controller at the previously specified physical machine location, and then continues to place the indicated call via the telephony network 220. Upon placing the call, the outbound simulator 240-1 goes to a “wait” state.

On the inbound IVR machine 215, another instance of the user simulator 240-2 is registered as the application for IVR product 255-2 to load for incoming calls. When IVR virtual machine 215 receives the incoming call (via IVR product 255-2), and when IVR product 255-2 loads user simulator 240-2, the user simulator 240-2 also establishes a connection to the call controller and enters a wait state. The use of configuration information 245-2 in this respect is similar to its use in IVR virtual machine 210.

When call controller 235 determines that a pairing has occurred, it then indicates as such to the test driver 230. Test driver 230 now (via the call controller 235) has a direct channel to both sides of the call and starts to send commands to one side, the other or both in order to play out the test case activity specified in the test case definition file 225. These commands are implemented as synchronous activity in order to ensure the test case remains deterministic and may return values to be validated by the test driver. When the activities either complete or fail to complete, the test driver 230 tells the user simulators 240-1 and 240-2 to disconnect the call and to then disconnect from the call controller, thus completing the test case loop.

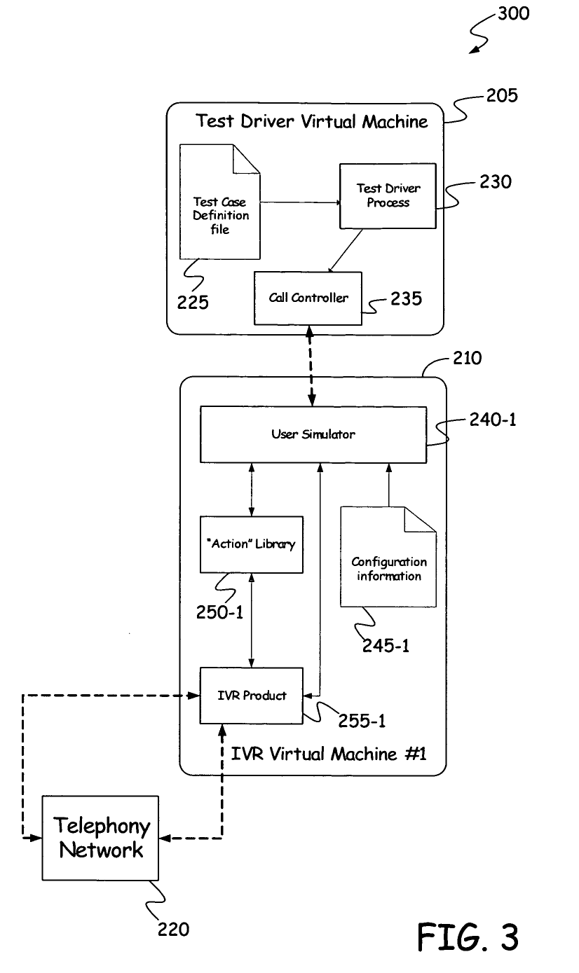

Referring now to FIG. 3, illustrated is a system 300 which operates substantially similar to system 200 as described above, but which uses only one IVR virtual machine 210. In this case, the call controller can configure user simulator 240-1 to function as both the outbound user simulator and as the inbound user simulator. To fully perform a test case of the type which simulates both ends as described above, IVR product 255-1 would then need two connections to the telephony network 220 in order to trigger both generation of an outbound call, and receipt of an inbound call. In disclosed embodiments, telephony network 220 is not limited to implementing only two-party calls, but instead refers to any telephony network, including those handling conference calls, call transfers, etc. A telephony network is any connection or series of connections whose intent or purpose is to enable voice communication between two or more people.

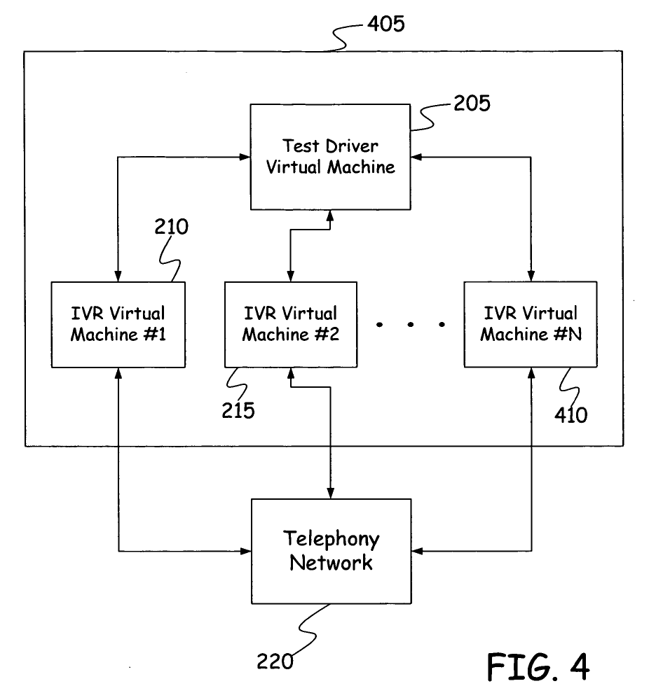

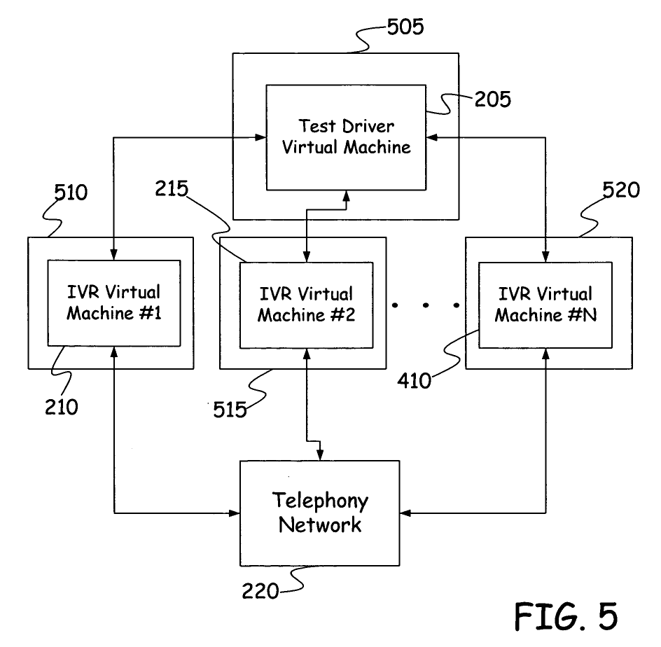

Referring now to FIGS. 4 and 5, shown are block diagrams illustrating aspects of disclosed embodiments in which the test driver virtual machine 205 and one or more IVR virtual machines (N virtual machines are represented) 210, 215 and 410 can reside on the same or different physical machines. In FIG. 4, all of virtual machines 205, 210, 215 and 410 are represented as residing on one computing environment or physical machine 405. In contrast, in FIG. 5, each of virtual machines 205, 210, 215 and 410 are shown to reside on one of four different physical machines 505, 510, 515 and 520. Of course, those of skill in the art will recognize that other combinations are equally applicable, with two or more virtual machines residing on one physical machine, while one or more other virtual machines reside on other physical machines.

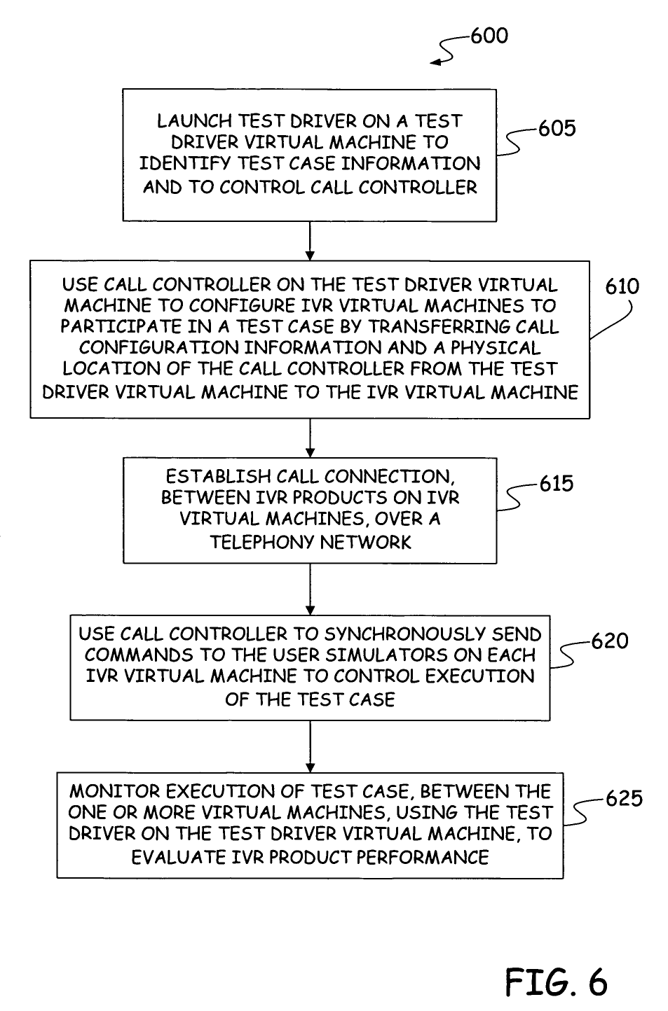

Referring now to FIG. 6, shown is a flow diagram 600 representing a method embodiment of executing test cases on IVR systems in a network independent manner. A network independent manner indicates the fact that it is not of primary importance how the two IVR's are connected, but rather just that they are connected. This method embodiment is a further representation of the above discussion, and is not intended to limit other method embodiments described herein. As can be seen in FIG. 6, the illustrated method embodiment includes the step 605 of launching test driver 230 on test driver virtual machine 205 to identify test case information and to control call controller 235. This step can include loading a test case definition file 225 indicative of call configuration characteristics and test case activity information, as was previously described.

Then, at step 610, the call controller 235 is used to configure one or more IVR virtual machines (e.g., virtual machines 210; 215) to participate in a test case. As described above, each IVR virtual machine implements a user simulator 240 and an IVR product 255 to be tested by the test case. Configuring each IVR virtual machine includes, as described above, transferring call configuration information and a physical location of the call controller 235 from the test driver virtual machine 205 to the IVR virtual machine(s) 210 and 215.

At step 615, the method embodiment includes establishing a call connection between IVR products 255-1 and 255-2, on the IVR virtual machines, over a telephony network 220. Then, the method includes step 620 of using the call controller to synchronously send commands to the user simulators on each IVR virtual machine to control execution of the test case using the call connection. The method also includes the step 625 of monitoring execution of the test case, between the virtual machines, using the test driver 230. Such monitoring allows IVR product performance to be evaluated and improved.

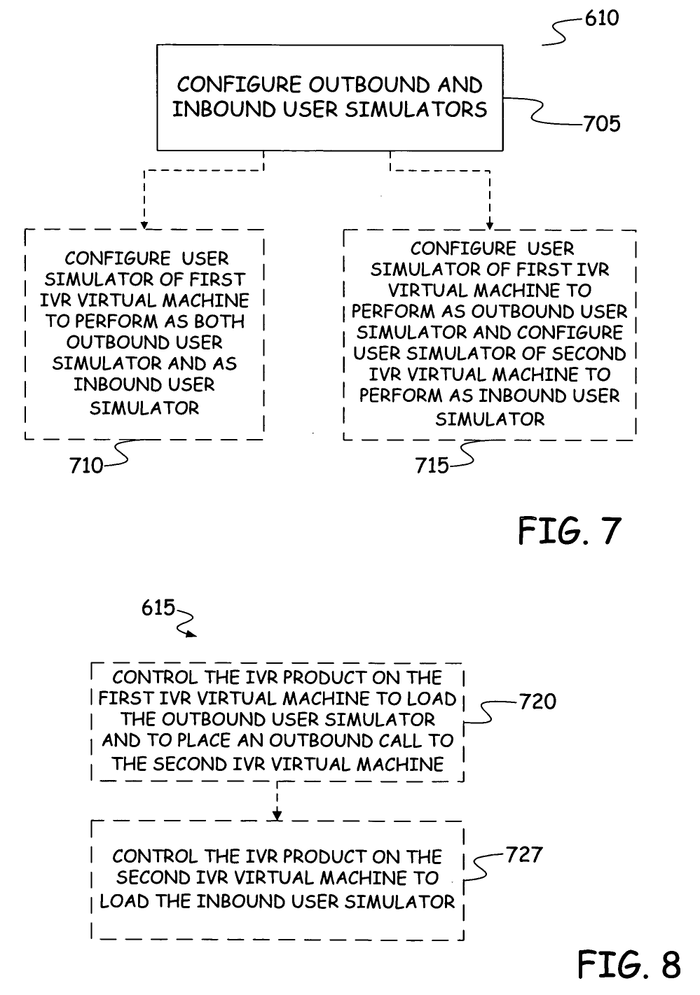

Referring now to FIG. 7, shown are alternate more particular embodiments of method step 610 shown in FIG. 6. In some embodiments as illustrated, step 610 further includes step 705 of configuring an outbound user simulator and configuring an inbound user simulator (for instance, simulators 240-1 and 240-2, respectively, in the above examples). However, in one embodiment, step 705 of configuring the outbound user simulator and the inbound user simulator is more specifically embodied in step 710 of configuring the user simulator 240-1 of a first IVR virtual machine 210 to perform as both the outbound user simulator and as the inbound user simulator. In these alternative embodiments, step 615 of establishing the call connection between IVR products on the one or more IVR virtual machines over the telephony network includes establishing an outbound call from the IVR product on the first IVR virtual machine, over the telephony network, to the same IVR product on the first IVR virtual machine. In other words, from IVR product 255-1 to IVR product 255-1 as illustrated in FIG. 3.

In the alternative represented in FIG. 2, however, step 705 of configuring the outbound user simulator includes the above-described steps of configuring a user simulator of a first IVR virtual machine 210 to perform as the outbound user simulator, and configuring the inbound user simulator includes configuring a user simulator of a second IVR virtual machine 215 to perform as the inbound user simulator. This embodiment is represented at step 715 in FIG. 7.

Referring now to FIG. 8, shown is a more specific embodiment of step 615 of establishing the call connection between IVR products on the one or more IVR virtual machines. In this illustrated embodiment, step 615 further includes step 720 of controlling the IVR product 255-1 on the first IVR virtual machine 210 to load the outbound user simulator 240-1 and to place an outbound call to the second IVR virtual machine 215. This embodiment of step 615 also includes step 727 of controlling the IVR product 255-2 on the second IVR virtual machine 215 to load the inbound user simulator 240-2.

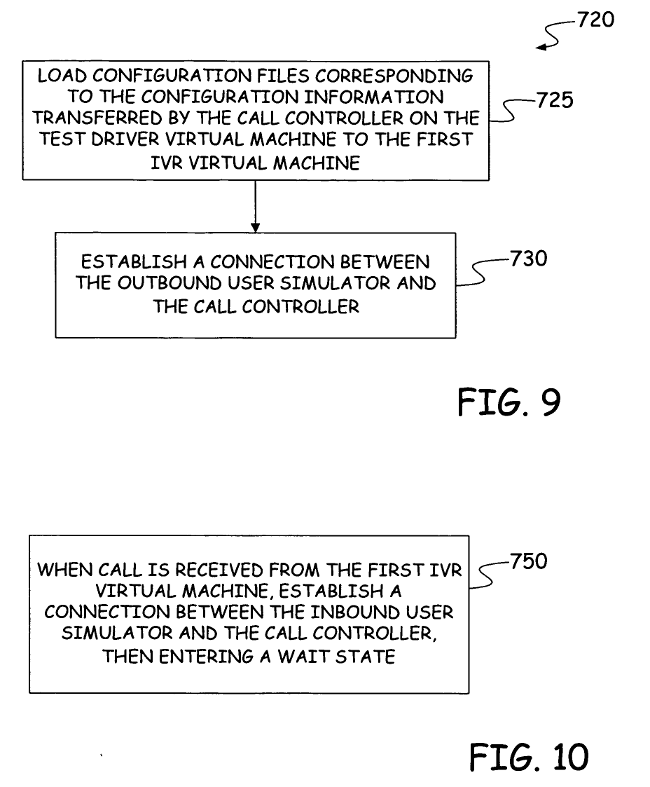

Now referring to FIG. 9, shown is one more particular embodiment of step 720 illustrated in FIG. 8. In this example embodiment, step 720 of controlling the IVR product 255-1 on the first IVR virtual machine 210 to load the outbound user simulator 240-1 further includes step 725 of loading configuration files corresponding to the configuration information transferred by the call controller on the test driver virtual machine to the first IVR virtual machine. In these embodiments, step 720 further includes step 730 of establishing a connection between the outbound user simulator and the call controller.

Referring now to FIG. 10, shown is an additional method embodiment step used when the call is received from the first IVR virtual machine 210. Using additional step 750, when the call is received from the first IVR virtual machine 210, a connection is established between the inbound user simulator 240-2 and the call controller 235. After the connection is established, user simulator 240-2 enters a wait state.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A network independent computer-implemented method of executing test cases on interactive voice response (IVR) systems, the method comprising:
launching a test driver on a test driver virtual machine to identify test case information and to control a call controller residing on the test driver virtual machine;
using the call controller on the test driver virtual machine to configure one or more IVR virtual machines to participate in a test case, each IVR virtual machine implementing a user simulator and an IVR product to be tested by the test case, wherein configuring each IVR virtual machine comprises transferring call configuration information and a physical location of the call controller from the test driver virtual machine to the IVR virtual machine;
establishing a call connection between IVR products on the one or more IVR virtual machines over a telephony network;
using the call controller to synchronously send commands to the user simulators on each IVR virtual machine to control execution of the test case using the call connection; and
monitoring execution of the test case, between the one or more virtual machines, using the test driver on the test driver virtual machine, to evaluate IVR product performance.

2. The computer-implemented method of claim 1, wherein launching the test driver on the test driver virtual machine to identify test case information further comprises loading a test case definition file indicative of call configuration characteristics and test case activity information.

3. The computer-implemented method of claim 1, wherein using the call controller on the test driver virtual machine to configure the one or more IVR virtual machines to participate in the test case further comprises configuring at least one outbound user simulator and configuring at least one inbound user simulator.

4. The computer-implemented method of claim 3, wherein configuring the at least one outbound user simulator and configuring the at least one inbound user simulator further comprises configuring a user simulator of a first IVR virtual machine to perform as both the outbound user simulator and as the inbound user simulator, and wherein establishing the call connection between IVR products on the one or more IVR virtual machines over the telephony network further comprises establishing an outbound call from the IVR product on the first IVR virtual machine, over the telephony network, to the same IVR product on the first IVR virtual machine.

5. The computer-implemented method of claim 3, wherein configuring the at least one outbound user simulator further comprises configuring a user simulator of a first IVR virtual machine to perform as the outbound user simulator, and wherein configuring the at least one inbound user simulator further comprises configuring a user simulator of a second IVR virtual machine to perform as the inbound user simulator.

6. The computer-implemented method of claim 5, wherein establishing the call connection between IVR products on the one or more IVR virtual machines further comprises controlling the IVR product on the first IVR virtual machine to load the outbound user simulator and to place an outbound call to the second IVR virtual machine.

7. The computer-implemented method of claim 6, wherein controlling the IVR product on the first IVR virtual machine to load the outbound user simulator further comprises:
loading configuration files corresponding to the configuration information transferred by the call controller on the test driver virtual machine to the first IVR virtual machine; and
establishing a connection between the outbound user simulator and the call controller.

8. The computer-implemented method of claim 7, and after establishing the connection between the outbound user simulator and the call controller, the outbound user simulator and the IVR product on the first IVR virtual machine are controlled to place the outbound call to the second IVR virtual machine and, upon placing the call, to enter a wait state.

9. The computer-implemented method of claim 8, wherein establishing the call connection between IVR products further comprises controlling the IVR product on the second IVR virtual machine to load the inbound user simulator.

10. The computer-implemented method of claim 9, and when the call is received from the first IVR virtual machine, further comprising establishing a connection between the inbound user simulator and the call controller, then entering a wait state.

11. A system for executing test cases on interactive voice response (IVR) products, the system comprising:
a first IVR virtual machine configured to implement components comprising:
a first IVR product to be tested, the first IVR product being connected to a telephony network; and
a first user simulator;
a test driver virtual machine configured to implement components comprising:
a call controller; and
a test driver which identifies test case information for a test case and in response controls the call controller; and
wherein the call controller controls the first IVR virtual machine to configure the first user simulator for the test case by transferring call configuration information and a physical location of the call controller from the test driver virtual machine to the first IVR virtual machine, and wherein the call controller controls the first IVR product to load the first user simulator, to establish a call connection from the first IVR product over the telephony network, to establish a connection between the first user simulator and the call controller at the physical location, and to control execution of the test case for evaluating the first IVR product performance.

12. The system of claim 11, and further comprising a second IVR virtual machine configured to implement components comprising:
a second IVR product, the second IVR product being connected to the telephony network;
a second user simulator; and
wherein the call controller controls the first IVR virtual machine to configure the first user simulator to be an outbound user simulator for the test case and controls the second IVR virtual machine to configure the second user simulator to be an inbound user simulator for the test case, wherein the call controller configures the second IVR product to load the second user simulator, wherein the call controller controls the first IVR virtual machine to establish the call connection with the second IVR virtual machine, and wherein the call controller synchronously sends commands to the outbound and inbound user simulators to control execution of the test case using the call connection.

13. The system of claim 11, wherein the first IVR virtual machine, the second IVR virtual machine and the test driver virtual machine reside on separate physical computing devices.

14. The system of claim 11, wherein the first IVR virtual machine, the second IVR virtual machine and the test driver virtual machine reside on a same physical computing device.

15. The system of claim 11, wherein the first and second virtual machines are further configured to store action libraries, wherein each action library contains synchronous functions that automate the IVR product on the corresponding virtual machine, each user simulator interfacing with its corresponding IVR product through the corresponding action library.

16. The system of claim 11, wherein the test driver virtual machine is further configured to store a test case definition file, wherein the test driver is configured to load the test case definition file to identify the test case information.

17. The system of claim 11, wherein the call controller controls the first IVR virtual machine to configure the first user simulator to be both an outbound user simulator for the test case and an inbound user simulator for the test case, wherein the call controller controls the first IVR virtual machine to establish the call connection with itself over the telephony network, and wherein the call controller synchronously sends commands to the user simulator to control execution of the test case using the call connection.

18. A computer-readable medium having stored thereon computer-executable instructions for implementing a method of executing test cases on interactive voice response (IVR) systems, the method comprising:
launching a test driver on a test driver virtual machine, by loading a test case definition file, to identify test case information and to control a call controller residing on the test driver virtual machine;
using the call controller on the test driver virtual machine to configure one or more IVR virtual machines to participate in a test case, each IVR virtual machine implementing a user simulator and an IVR product to be tested by the test case, wherein configuring the one or more IVR virtual machines further comprises configuring at least one outbound user simulator and at least one inbound user simulator;
establishing a call connection between IVR products on the one or more IVR virtual machines over a telephony network;
using the call controller to synchronously send commands to or receive commands from the user simulators on each IVR virtual machine to control execution of the test case using the call connection; and
monitoring execution of the test case, between the one or more virtual machines, using the test driver on the test driver virtual machine, to evaluate IVR product performance.

19. The computer-readable medium of claim 18, wherein configuring the at least one outbound user simulator and at least one inbound user simulator further comprises configuring a user simulator of a first IVR virtual machine to perform as both the outbound user simulator and as the inbound user simulator, and wherein establishing the call connection between IVR products on the one or more IVR virtual machines over the telephony network further comprises establishing an outbound call from the IVR product on the first IVR virtual machine, over the telephony network, to the same IVR product on the first IVR virtual machine.

20. The computer-readable medium of claim 18, wherein configuring the at least one outbound user simulator and at least one inbound user simulator further comprises configuring a user simulator of a first IVR virtual machine to perform as the outbound user simulator and configuring a user simulator of a second IVR virtual machine to perform as the inbound user simulator.
